(19) United States
(12) Patent Application Publication
(10) Pub. No.: US 2025/0309277 A1
(43) Pub. Date: Oct. 2, 2025

(54) ELECTRODE PLATE, SECONDARY BATTERY, AND ELECTRONIC DEVICE

(71) Applicant: Ningde Amperex Technology Limited, Ningde (CN)

(72) Inventors: Shengkai LI, Ningde (CN); Limin YU, Ningde (CN); Nanxi LV, Ningde (CN); Dongou ZHAN, Ningde (CN)

(73) Assignee: Ningde Amperex Technology Limited, Ningde (CN)

(21) Appl. No.: 19/089,476

(22) Filed: Mar. 25, 2025

(30) Foreign Application Priority Data
Mar. 26, 2024 (CN) 202410354656.7

(51) Int. Cl. H01M 4/70; H01M 4/02; H01M 10/058; H01M 50/557

(52) U.S. Cl. CPC H01M 4/70; H01M 10/058; H01M 50/557; H01M 2004/021; H01M 2004/027

(57) ABSTRACT

An electrode plate includes a current collector and an active material layer that are stacked. The electrode plate is provided with N first regions. The active material layer in each first region is provided with a groove. An (S+1)^{th} first region is closer to a center of the electrode plate than an S^{th} first region. A depth of the groove located in the S^{th} first region is H_{S}, and a depth of the groove located in the (S+1)^{th} first region is H_{S+1}, satisfying: H_{S}<H_{S+1}, where N is a positive integer greater than or equal to 2, and S is a positive integer greater than or equal to 1 and less than N. The depths of the grooves in a plurality of first regions of the electrode plate in this application change in a gradient from the periphery to the center of the electrode plate.

### CROSS-REFERENCE TO RELATED APPLICATION

The present application claims priority to Chinese Patent application No. CN 202410354656.7 filed in the China National Intellectual Property Administration on Mar. 26, 2024, the entire content of which is hereby incorporated by reference.

### TECHNICAL FIELD

This application relates to the technical field of energy storage, and in particular, to an electrode plate, a secondary battery, and an electronic device.

### BACKGROUND

With the popularization of electronic devices such as mobile phones and laptop computers, the operating conditions are increasingly complicated, and the safety requirements for secondary batteries are increasingly higher.

An electrolyte solution in the secondary battery is a medium for lithium ion migration and charge transfer. To ensure that an active material can be sufficiently utilized, voids between each electrode plate and a separator in the secondary battery are required to be filled with the electrolyte solution. The amount of the electrolyte solution exerts a significant effect on the capacity and cycle performance of the secondary battery. Ensuring sufficient electrolyte solution between the electrode plate and the separator is conducive to ample exertion of the capacity of the active material.

Currently, in a process of preparing a secondary battery, some problems are prone to occur, for example, insufficient electrolyte solution between the electrode plate and the separator, and electrolyte loss during the use of the secondary battery. These problems cause insufficient infiltration of the electrode plate and the separator, result in a large internal resistance of the electrode plate and insufficient exertion of the capacity, and give rise to the phenomena such as electrolyte flow discontinuity and occurrence of black flecks.

### SUMMARY

In view of the above situation, this application provides an electrode plate, a secondary battery, and an electronic device to improve the electrolyte infiltration degree of the electrode plate and reduce the capacity loss of the electrode plate.

According to a first aspect of this application, an electrode plate is provided. The electrode plate includes a current collector and an active material layer that are stacked. The electrode plate is provided with N first regions. The active material layer in each first region is provided with a groove. An (S+1)^{th} first region is closer to a center of the electrode plate than an S^{th} first region. A depth of the groove located in the S^{th} first region is H_{S}, and a depth of the groove located in the (S+1)^{th} first region is H_{S+1}, satisfying: H_{S}<H_{S+1}, where N is a positive integer greater than or equal to 2, and S is a positive integer greater than or equal to 1 and less than N.

In the above embodiment, a plurality of grooves on the electrode plate allow more electrolyte solution to be accommodated between the electrode plate and the separator, thereby improving the electrolyte infiltration degree of the electrode plate. The depths of the grooves in a plurality of first regions change in a gradient from the periphery to the center of the electrode plate. The groove in the first region closer to the center of the electrode plate is deeper, thereby improving the electrolyte infiltration effect in the region close to the center on the electrode plate. In addition, the groove in the first region located at the periphery that can be infiltrated without difficulty is narrower in depth, thereby making it convenient to provide a larger amount of active material layer, and in turn, reducing the capacity loss of the electrode plate.

In one or more embodiments, the center of the electrode plate is located in an N^{th} first region.

In the above embodiments, the center of the electrode plate is located in the first region with the deepest groove, thereby further improving the electrolyte infiltration effect in the region close to the center on the electrode plate.

In one or more embodiments, a center of the N^{th} first region coincides with the center of the electrode plate.

In the above embodiments, the center of the N^{th} first region coincides with the center of the electrode plate. In this way, the first region with the deepest groove is located at the center of the electrode plate, thereby further improving the electrolyte infiltration effect in the region close to the center on the electrode plate.

In one or more embodiments, the N^{th} first region accounts for 20% to 50% of an area of the electrode plate.

In the above embodiments, the first region with the deepest groove is located at the center of the electrode plate, and the first region located at the center of the electrode plate accounts for 20% to 50% of the area of the electrode plate. When the area of the first region with the deepest groove satisfies the above range, the probability of electrolyte flow discontinuity and occurrence of black flecks at the center of the electrode plate is further reduced, and the capacity loss of the electrode plate is reduced.

In one or more embodiments, Nis 3, and a sum of areas of the 3 first regions is less than or equal to an area of the electrode plate. Each first region accounts for 20% to 40% of the area of the electrode plate.

In the above embodiment, the depths of the grooves are distributed in three gradient levels, and the improvement degrees contributed by the grooves at different gradient levels are made more uniform, thereby improving the electrolyte infiltration effect of the entire electrode plate, reducing the risk of electrolyte flow discontinuity and occurrence of black flecks, and reducing the capacity loss of the electrode plate.

In one or more embodiments, a depth of the groove in the 1^{st} first region is H₁, satisfying: 0<H_{S+1}−H_{S}<H₁.

In the above embodiments, when H_{S+1}−H_{S} satisfies the specified range 0<H_{S+1}−H_{S}<H₁, the difference in groove depth between the two adjacent first regions is prevented from exceeding the depth of the narrowest groove, thereby making it convenient for the electrode plate to form more gradient levels, and reducing the capacity loss of the electrode plate. With the specified range satisfied, the amount of electrolyte solution between the electrode plate and the separator can also be increased, thereby not only improving the electrolyte infiltration effect of the electrode plate, but also reducing the capacity loss of the electrode plate.

In one or more embodiments, 5 μm≤H_{S+1}−H_{S}≤15 μm.

In the above embodiments, when H_{S+1}−H_{S} satisfies the specified range 5 μm≤H_{S+1}−H_{S}≤15 μm, the difference in groove depth between the two adjacent first regions is prevented from being excessively large, thereby making it convenient for the electrode plate to form more gradient levels, and reducing the capacity loss of the electrode plate. Satisfying the specified range also prevents the difference in groove depth between the two adjacent first regions from being excessively small, thereby making it convenient to increase the amount of electrolyte solution between the electrode plate and the separator, and in turn, making it convenient to improve the electrolyte infiltration effect of the electrode plate, and achieving a more reasonable trade-off between the improvement of the electrolyte infiltration effect of the electrode plate and the reduction of the capacity loss.

In one or more embodiments, a depth of the groove in an N^{th} first region is 21 μm to 40 μm.

In the above embodiment, the depths of the grooves in the N^{th} first region are 21 μm to 40 μm, thereby increasing the amount of electrolyte solution between the first region located at the center of the electrode plate and the separator, and improving the electrolyte infiltration effect at the center of the electrode plate, and in turn, further reducing the probability of electrolyte flow discontinuity and occurrence of black flecks at the center of the electrode plate.

In one or more embodiments, along a direction perpendicular to a thickness direction of the electrode plate, at least a part of the grooves penetrate through the active material layer.

In the above embodiments, the groove penetrates through the active material layer along the direction perpendicular to the thickness direction of the electrode plate, thereby making it convenient for the electrolyte solution to enter the clearance between the electrode plate and the separator through the groove, and in turn, improving the electrolyte infiltration effect and reducing the risk of electrolyte flow discontinuity and occurrence of black flecks.

In one or more embodiments, a width of the groove is 80 μm to 120 μm.

In the above embodiment, when the width W of the groove satisfies the specified range of 80 μm to 120 μm, the amount of electrolyte solution between the electrode plate and the separator can be increased, thereby improving the electrolyte infiltration effect between the electrode plate and the separator, reducing the capacity loss of the electrode plate, and in turn, reducing the probability of electrolyte flow discontinuity and occurrence of black flecks.

In one or more embodiments, a distance between any two adjacent grooves is 0.5 mm to 2.5 mm.

In the above embodiments, when the distance between any two adjacent grooves satisfies the specified range of 0.5 mm to 2.5 mm, the grooves are prevented from being excessively dense or sparse, thereby making it convenient for the electrode plate to maintain a sufficient amount of active material layer, reducing the capacity loss of the electrode plate, increasing the amount of electrolyte solution between the electrode plate and the separator, and in turn, improving the electrolyte infiltration effect between the electrode plate and the separator.

In one or more embodiments, the electrode plate further includes an electrode terminal. The electrode terminal is connected to the current collector. Along an extension direction of the groove, the electrode terminal is located on one side of the current collector. The active material layer includes a first part and a second part. The first part is stacked together with the current collector, and the second part is stacked together with a part of the electrode terminal. Along the extension direction of the groove, a minimum distance between the groove and an edge, oriented away from the first part, of the second part is 0.1 mm to 1 mm.

In the above embodiment, along the extension direction of the groove, a minimum distance between the groove and an edge, oriented away from the first part, of the second part is 0.1 mm to 1 mm. In this way, the processing region is distanced from a part, uncoated with an active material layer, of the electrode terminal, thereby reducing the risk of damage to the electrode terminal during the processing of the groove.

In one or more embodiments, the S^{th} first region surrounds the (S+1)^{th} first region.

In the above embodiments, all the 1^{st} to (N-1)^{th} first regions are rectangular regions or annular regions, thereby making a plurality of first regions more compliant with the law of electrolyte infiltration, and more favorably improving the electrolyte infiltration effect of the electrode plate and reducing the capacity loss of the electrode plate simultaneously.

In one or more embodiments, along a direction perpendicular to a thickness direction of the electrode plate, a part of the S^{th} first region is located on one side of the (S+1)^{th} first region, and another part of the S^{th} first region is located on an opposite side of the (S+1)^{th} first region.

In the above embodiments, the arrangement of the plurality of grooves is simpler, thereby improving the processing efficiency of the grooves.

In one or more embodiments, the electrode plate is a negative electrode plate.

In the above embodiments, the consumption speed of the electrolyte solution between the negative electrode plate and the separator is faster than the consumption speed of the electrolyte solution between the positive electrode plate and the separator. When the technical solution about the groove and the first region in any one of the above embodiments is applied to the negative electrode plate, the electrolyte infiltration is improved to a greater degree, thereby being more conducive to reducing the risk of electrolyte flow discontinuity and occurrence of black flecks.

According to a second aspect, a secondary battery is further disclosed. The secondary battery includes an electrode assembly. The electrode assembly includes a separator and the negative electrode plate disclosed in any one of the above embodiments. The electrode assembly further includes a positive electrode plate. The separator is disposed between the negative electrode plate and the positive electrode plate.

In one or more embodiments, N second regions are disposed on the positive electrode plate. The (S+1)^{th} second region is closer to a center of the positive electrode plate than the S^{th} second region. Along a thickness direction of the negative electrode plate, a projection of an N^{th} first region overlaps a projection of an N^{th} second region. A ratio of a capacity of the N^{th} first region to a capacity of the N^{th} second region is C, satisfying: 1.02≤C≤1.5.

In the above embodiments, by making C satisfy the condition of 1.02≤C≤1.5, it is more convenient for the grooves in the first region to improve the electrolyte infiltration effect of the electrode plate and reduce the capacity loss of the electrode plate simultaneously. The improved electrolyte infiltration effect of the electrode plate and the reduced capacity loss are conducive to improving the reliability and energy density of the secondary battery.

A third aspect of this application further provides an electronic device. The electronic device includes the secondary battery disclosed in any one of the above embodiments.

In the above embodiments, the reliability and energy density of the secondary battery are improved, thereby improving the performance and reliability of the electronic device.

The electrode plate in this application includes a current collector and an active material layer that are stacked. The electrode plate is provided with N first regions. The active material layer in each first region is provided with a groove. An (S+1)^{th} first region is closer to a center of the electrode plate than an S^{th} first region. A depth of the groove located in the S^{th} first region is H_{S}, and a depth of the groove located in the (S+1)^{th} first region is H_{S+1}, satisfying: H_{S}<H_{S+1}, where N is a positive integer greater than or equal to 2, and S is a positive integer greater than or equal to 1 and less than N. A plurality of grooves on the electrode plate allow more electrolyte solution to be accommodated between the electrode plate and the separator, thereby improving the electrolyte infiltration degree of the electrode plate. In addition, the depths of the grooves in a plurality of first regions of the electrode plate change in a gradient from the periphery to the center of the electrode plate, thereby improving the electrolyte infiltration degree of the region close to the center on the electrode plate and reducing the capacity loss of the electrode plate.

### BRIEF DESCRIPTION OF DRAWINGS

FIG. 1 is a schematic structural diagram of a secondary battery according to an embodiment of this application;

FIG. 2 is a schematic exploded view of a secondary battery according to an embodiment of this application;

FIG. 3 is a side view of an electrode plate according to an embodiment of this application;

FIG. 4 is a top view of an electrode plate according to an embodiment of this application;

FIG. 5 is a cross-sectional view of the electrode plate shown in FIG. 4 sectioned along an I-I section line;

FIG. 6 is a cross-sectional view of the electrode plate shown in FIG. 4 sectioned along an II-II section line;

FIG. 7 is a top view of an electrode plate according to another embodiment of this application;

FIG. 8 is a top view of an electrode plate according to still another embodiment of this application; and

FIG. 9 is a schematic diagram of an electronic device according to an embodiment of this application.

### LIST OF REFERENCE NUMERALS

secondary battery 100
housing 10
electrode assembly 20
electrode plate 21
first region 210
current collector 211
active material layer 212
first part 2121
second part 2122
electrode terminal 213
first tab 2131
second tab 2132
groove 214
width direction of the electrode plate X
length direction of the electrode plate Y
thickness direction of the electrode plate Z
device body 200
electronic device 1000

### DETAILED DESCRIPTION

The following describes the technical solutions in some embodiments of this application with reference to the drawings hereof. Evidently, the described embodiments are merely a part of but not all of the embodiments of this application.

It is hereby noted that in this application, the center of an electrode plate refers to the center of gravity of the electrode plate of a layered structure. Understandably, the center of gravity of the layered structure can be determined by a hanging method. Specifically, the hanging method is: suspending the layered structure by a thin wire, and making a straight line in the vertical direction from the starting point of the thin wire; suspending the layered structure for a second time from an endpoint different from the endpoint used at the first time; and making another straight line by the same method; and determining that the intersection of the two straight lines is the center of gravity of the planar shape.

It is hereby noted that unless otherwise expressly specified and defined, the terms “mount”, “concatenate”, “connect”, and “fix” need to be understood in a broad sense. For example, such terms may refer to a fixed connection, a detachable connection, or an integrated connection, and may be a mechanical connection or an electrical connection. A component considered to be “connected” to another component may be directly connected to the other component or may be connected to the other component through an intermediate component. A component considered to be “disposed on” another component may be directly disposed on the other component or may be disposed on the other component through an intermediate component.

Unless otherwise expressly specified, the term “a plurality of” as used herein means two or more.

The technical terms “first” and “second” are merely intended to distinguish between different items but not intended to indicate or imply relative importance or implicitly specify the number of the indicated technical features, specific order, or order of precedence.

The term “perpendicular” is a description of an ideal state between two components. In the actual production or use state, one component may be approximately perpendicular to another component. For example, numerically, the term “perpendicular” may represent an angle of 90°±10° between two straight lines, or a dihedral angle of 90°±10° between two planes, or an angle of 90°±10° between a straight line and a plane.

The term “parallel” is a description of an ideal state between two components. In an actual production or use state, one component may be approximately parallel to another component. For example, numerically, the term “parallel” may represent an angle of 180°±10° between two straight lines, or a dihedral angle of 180°±10° between two planes, or an angle of 180°±10° between a straight line and a plane.

It is hereby noted that a parameter described as being greater than, equal to, or less than a specified endpoint value means that the endpoint value allows for a tolerance of +5%.

It is hereby noted that the dimensions of the layers, regions, films, plates, blocks, columns, protrusions, recesses, and the like shown in the drawings are given for better understanding and more convenient description. This application is not limited to the dimensions shown in the drawings. To make this application clear, the elements not related to the description are omitted from the details of this specification.

Unless otherwise defined, all technical and scientific terms used herein bear the same meanings as what is normally understood by a person skilled in the technical field of this application. The terms used in the specification of this application are merely intended to describe specific embodiments but not to limit this application.

In the related art, in a process of preparing a secondary battery, some problems are prone to occur, for example, insufficient electrolyte solution between the electrode plate and the separator, and electrolyte loss during the use of the secondary battery. These problems are prone to cause insufficient infiltration of the electrode plate and incomplete infiltration of the separator, thereby resulting in a large internal resistance of the electrode plate, insufficient exertion of the capacity, and giving rise to the phenomena such as electrolyte flow discontinuity and occurrence of black flecks.

This application discloses an electrode plate. The electrode plate includes a current collector and an active material layer that are stacked. The electrode plate is provided with N first regions. The active material layer in each first region is provided with a groove. An (S+1)^{th} first region is closer to a center of the electrode plate than an S^{th} first region. A depth of the groove located in the S^{th} first region is H_{S}, and a depth of the groove located in the (S+1)^{th} first region is H_{S+1}, satisfying: H_{S}<H_{S+1}, where N is a positive integer greater than or equal to 2, and S is a positive integer greater than or equal to 1 and less than N.

A plurality of grooves on the electrode plate allow more electrolyte solution to be accommodated between the electrode plate and the separator, thereby improving the electrolyte infiltration degree of the electrode plate. In addition, the depths of the grooves in a plurality of first regions of the electrode plate change in a gradient from the periphery to the center of the electrode plate, thereby improving the electrolyte infiltration degree of the region close to the center on the electrode plate and reducing the capacity loss of the electrode plate.

The following describes some embodiments of this application with reference to drawings. To the extent that no conflict occurs, the following embodiments and the features in the embodiments may be combined with each other.

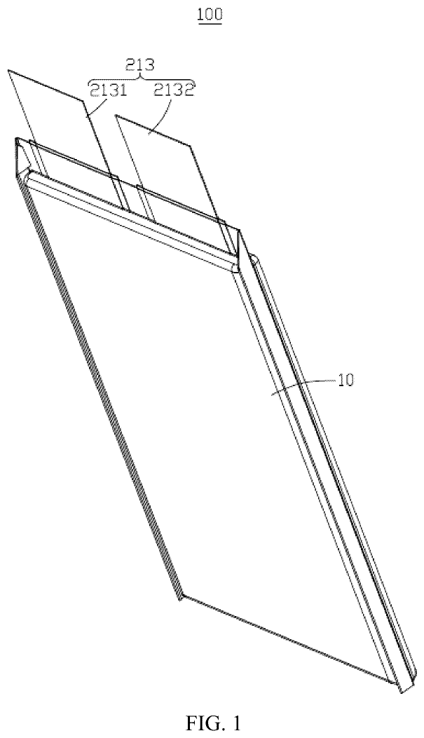

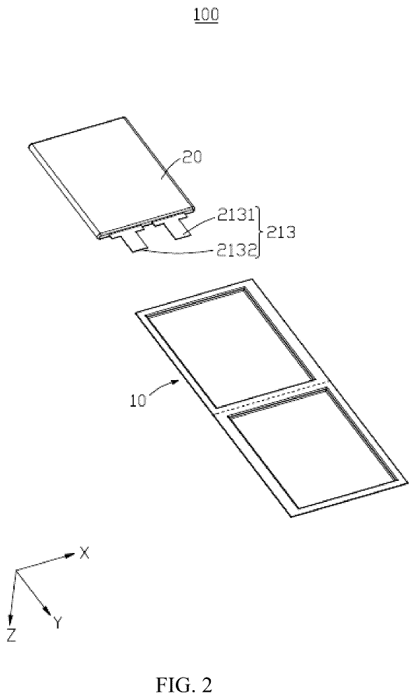

Referring to FIG. 1 and FIG. 2, an embodiment of this application provides a secondary battery 100. The secondary battery 100 includes a housing 10 and an electrode assembly 20. The housing 10 accommodates the electrode assembly 20.

In some embodiments, the secondary battery 100 is a pouch-type battery, and the housing 10 is an aluminum laminated film. In some other embodiments, the secondary battery 100 is a hard-shell battery, and the material of the housing 10 includes any one or more of plastic, steel, or aluminum.

In some embodiments, an electrolyte solution (not shown) is further provided in the housing 10. The electrolyte solution contains a lithium salt and a solvent. The lithium salt may include at least one of LiPF, LiBF, LiCIO, LiB(CH), LICHSO, LiCFSOLIN (SOCF), LiC(SOCF), or LiBOB. The solvent may be a carbonate ester compound, a carboxylate ester compound, an ether compound, another organic solvent, or any combination thereof.

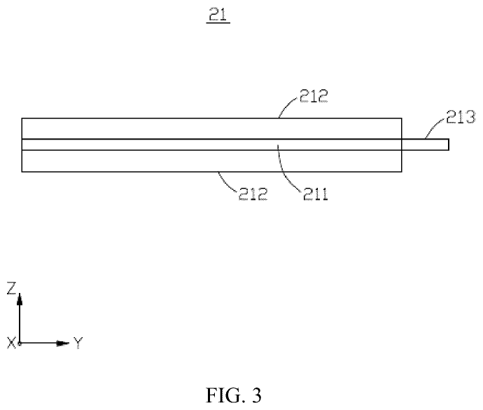

In some embodiments, referring to FIG. 2 and FIG. 3, the electrode assembly 20 includes an electrode plate 21. The electrode plate 21 includes a current collector 211 and an active material layer 212 that are stacked.

In some embodiments, the electrode plate 21 is a negative electrode plate. In some other embodiments, the electrode plate 21 is a positive electrode plate.

In some embodiments, the electrode assembly 20 includes a positive electrode plate, a negative electrode plate, and a separator disposed between the positive electrode plate and the negative electrode plate. The separator is configured to separate the positive electrode plate from the negative electrode plate.

In some embodiments, the positive electrode plate, the separator, and the negative electrode plate are stacked to form a stacked structure. In some other embodiments, the positive electrode plate, the separator, and the negative electrode plate are stacked and then wound to form a jelly-roll structure.

In some embodiments, the positive electrode plate includes a positive current collector and a positive active material layer that are stacked. The negative electrode plate includes a negative current collector and a negative active material layer that are stacked.

In some embodiments, the positive current collector may be a metal layer containing at least one of aluminum, nickel, tantalum, or titanium, such as aluminum foil. The negative current collector may be a metal layer containing at least one of copper, nickel, tantalum, or titanium, such as copper foil.

In some embodiments, the positive active material layer includes a positive active material. The positive active material may include at least one of lithium cobalt oxide, lithium nickel cobalt manganese oxide, lithium nickel cobalt aluminum oxide, lithium iron phosphate, lithium manganese iron phosphate, or lithium manganese oxide. The negative active material layer includes a negative active material. The negative active material may include at least one of graphite, hard carbon, soft carbon, silicon, a silicon-oxygen material, or a silicon-carbon material.

In some embodiments, the separator is an insulating film such as a polyethylene film, a polypropylene film, a polyester film, or a polyimide film.

In some embodiments, referring to FIG. 1 to FIG. 3, the secondary battery 100 further includes an electrode terminal 213. The electrode terminal 213 is connected to the current collector 211 of the electrode assembly 20. The electrode terminal 213 includes a first tab 2141 and a second tab 2142. The electrode assembly 20 is connected to the first tab 2141 and the second tab 2142. The first tab 2141 and the second tab 2142 extend out of the housing 10 from a top seal edge to lead the polarity of the electrode assembly 20 out of the housing 10.

In some embodiments, the first tab 2141 is connected to the positive electrode plate. The material of the first tab 2141 may be the same as the material of the positive current collector. The first tab 2141 is a positive tab. The second tab 2142 is connected to the negative electrode plate. The material of the second tab 2142 may be the same as the material of the negative current collector. The second tab 2142 is a negative tab.

In some other embodiments, the first tab 2141 is connected to the negative electrode plate. The material of the first tab 2141 may be the same as the material of the negative current collector. The first tab 2141 is a negative tab. The second tab 2142 is connected to the positive electrode plate. The material of the second tab 2142 may be the same as the material of the positive current collector. The second tab 2142 is a positive tab.

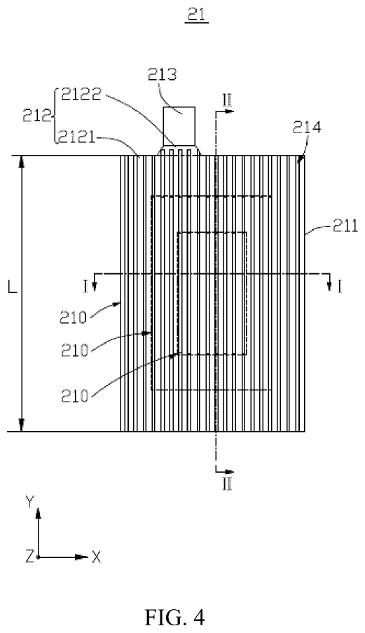

In some embodiments, referring to FIG. 4 to FIG. 6, the electrode plate 21 is provided with N first regions 210. The (S+1)^{th} first region 210 is closer to the center of the electrode plate 21 than the S^{th} first region 210. N is a positive integer greater than or equal to 2, and S is a positive integer greater than or equal to 1 and less than N. The active material layer 212 of each first region 210 is provided with a groove 214. The depth of the groove 214 located in the S^{th} first region 210 is H_{S}, and the depth of the groove 214 located in the (S+1)^{th} first region 210 is H_{S+1}, satisfying: H_{S}<H_{S+1}.

The applicant hereof finds through research that a region near the center of the electrode plate 21 can hardly be infiltrated, and the electrolyte solution in a region near the center of the electrode plate 21 can hardly be supplemented after being lost. In the above embodiment, a plurality of grooves 214 on the electrode plate 21 allow more electrolyte solution to be accommodated between the electrode plate 21 and the separator, thereby improving the electrolyte infiltration degree of the electrode plate 21. The depths of the grooves 214 in a plurality of first regions 210 change in a gradient from the periphery to the center of the electrode plate 21. The groove 214 in the first region 210 closer to the center of the electrode plate 21 is deeper, thereby improving the electrolyte infiltration effect in the region close to the center on the electrode plate 21 and suppressing the occurrence of black flecks. In addition, the groove 214 in the first region 210 located at the periphery that can be infiltrated without difficulty is narrower in depth, thereby making it convenient to provide a larger amount of active material layer 212, and in turn, reducing the capacity loss of the electrode plate 21 and suppressing lithium plating.

In some embodiments, the number of grooves 214 in each first region 210 may be one or more. When the number of grooves 214 in each first region 210 is more than one, the depths of the grooves 214 in the same first region 210 are substantially the same.

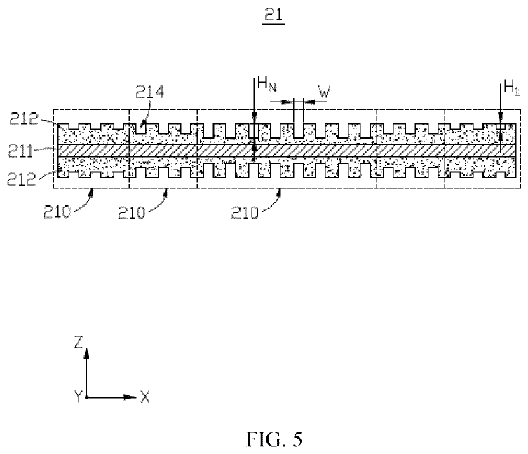

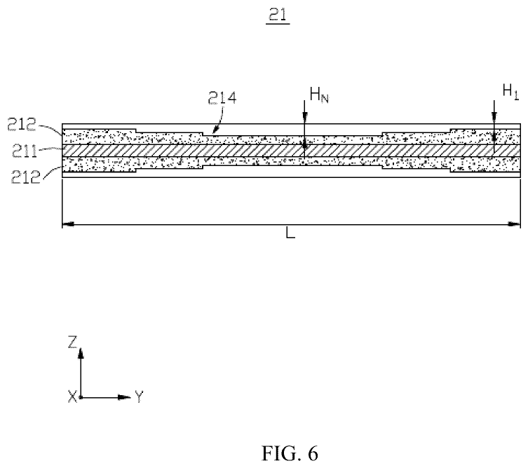

In some embodiments, referring to FIG. 5 and FIG. 6, along the thickness direction of the electrode plate 21, an active material layer 212 is disposed on two opposite sides of the current collector 211a separately. Grooves 214 are provided on the two active material layers 212 on the two opposite sides of the current collector 211 in each first region 210.

In some embodiments, referring to FIG. 4 and FIG. 5, the center of the electrode plate 21 is located in the N^{th} first region 210. The center of the electrode plate 21 is located in the first region 210 with the deepest groove 214, thereby further improving the electrolyte infiltration effect in the region close to the center on the electrode plate 21.

In the above embodiments, referring to FIG. 4 and FIG. 5, the center of the N^{th} first region 210 coincides with the center of the electrode plate 21. In this way, the first region 210 with the deepest groove 214 is located at the center of the electrode plate 21, thereby further improving the electrolyte infiltration effect in the region close to the center on the electrode plate 21.

In some embodiments, referring to FIG. 4 and FIG. 5, the center of the N^{th} first region 210 coincides with the center of the electrode plate 21, and the N^{th} first region 210 accounts for 20% to 50% of the area of the electrode plate 21. In this way, the first region 210 with the deepest groove 214 is located at the center of the electrode plate 21, and the first region 210 located at the center of the electrode plate 21 accounts for 20% to 50% of the area of the electrode plate 21. When the coverage of the first region 210 with the deepest groove 214 satisfies the above position and range, the probability of electrolyte flow discontinuity and occurrence of black flecks at the center of the electrode plate 21 is further reduced, and the capacity loss of the electrode plate 21 is reduced.

In some embodiments, referring to FIG. 4 and FIG. 5, N is 3, and a sum of areas of the 3 first regions 210 is less than or equal to the area of the electrode plate 21. Each first region 210 accounts for 20% to 40% of the area of the electrode plate 21. In this way, the depths of the grooves 214 are distributed in three gradient levels, and the improvement degrees contributed by the grooves at different gradient levels are made more uniform, thereby improving the electrolyte infiltration effect of the entire electrode plate 21, reducing the risk of electrolyte flow discontinuity and occurrence of black flecks, and reducing the capacity loss of the electrode plate 21.

In some embodiments, referring to FIG. 5 and FIG. 6, the depth of the groove 214 in the 1st first region 210 is H₁, satisfying: 0<H_{S+1}−H_{S}<H₁. When H_{S+1}−H_{S} satisfies the specified range 0<H_{S+1}−H_{S}<H₁, the difference in depth of grooves 214 between the two adjacent first regions 210 is prevented from exceeding the depth of the narrowest groove 214, thereby making it convenient for the electrode plate 21 to form more gradient levels, and reducing the capacity loss of the electrode plate 21. With the specified range satisfied, the amount of electrolyte solution between the electrode plate 21 and the separator can also be increased, thereby not only improving the electrolyte infiltration effect of the electrode plate 21, but also reducing the capacity loss of the electrode plate 21.

It is hereby noted that the (S+1)^{th} first region 210 is closer to the center of the electrode plate 21 than the S^{th} first region 210. In this way, the first region 210 farthest from the center of the electrode plate 21 among the N first regions 210 is the 1st first region 210, and the first region 210 closest to the center of the electrode plate 21 among the N first regions 210 is the N^{th} first region 210.

In some embodiments, 5 μm≤H_{S+1}−H_{S}≤15 μm. When H_{S+1}−H_{S} satisfies the specified range 5 μm≤H_{S+1}−H_{S}≤15 μm, the difference in depth of grooves 214 between the two adjacent first regions 210 is prevented from being excessively large, thereby making it convenient for the electrode plate 21 to form more gradient levels, and reducing the capacity loss of the electrode plate 21. Satisfying the specified range also prevents the difference in depth of grooves 214 between the two adjacent first regions 210 from being excessively small, thereby making it convenient to increase the amount of electrolyte solution between the electrode plate 21 and the separator, and in turn, making it convenient to improve the electrolyte infiltration effect of the electrode plate 21, and achieving a more reasonable trade-off between the improvement of the electrolyte infiltration effect of the electrode plate 21 and the reduction of the capacity loss.

As an example, H_{S+1}−H_{S} may be any one of 5 μm, 6 μm, 7 μm, 8 μm, 9 μm, 10 μm, 11 μm, 12 μm, 13 μm, 14 μm, or 15μ m.

In some embodiments, referring to FIG. 5 and FIG. 6, the depth of the groove 214 in the N^{th} first region 210 is 21 μm to 40 μm. The depth of the groove 214 in the N^{th} first region 210 is defined as H_{N}, satisfying: 21 μm≤H_{N}≤40 μm, so that the depth of the deepest groove 214 on the electrode plate 21 is 21 μm to 40 μm. This arrangement increases the amount of electrolyte solution between the first region 210 located at the center of the electrode plate 21 and the separator, and improves the electrolyte infiltration effect at the center of the electrode plate 21, and in turn, further reduces the probability of electrolyte flow discontinuity and occurrence of black flecks at the center of the electrode plate 21.

As an example, H_{N} may be any one of 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, or 40 μm.

In some embodiments, referring to FIG. 4 to FIG. 6, the depth of the groove 214 in the N^{th} first region 210 is H_{N}, the density of the active material layer 212 after the electrode plate 21 is compacted is p, the width of the groove 214 in the N^{th} first region 210 is W_{N}, the length of the groove in the N^{th} first region is L, and a mass loss of the electrode plate 21 caused by all the grooves 214 in the N^{th} first region 210 is T, satisfying: N×H_{N}=T/(W_{N}Lpn), where 0.5<n<1, and n is a coefficient obtained according to the shape of the groove 214. When the groove 214 is a triangular groove with a V-shaped opening, n=0.5. When the groove 214 is a rectangular groove, n=1. Based on a preset tolerable mass loss in the N^{th} first region 210, the depth of the groove 214 can be calculated.

For example, the mass of the electrode plate 21 in the N^{th} first region 210 is calculated as G, and N/G is preset to satisfy 1.1%≤N/G≤1.5%, that is, the tolerable mass loss in the N^{th} first region 210 is preset to be 1.1% to 1.5%. Such values are substituted into N×H_{N}=T/(W_{N}Lpn) to calculate the range of the depth of the groove 214 in the N^{th} first region 210.

In some embodiments, referring to FIG. 4 to FIG. 6, along a direction perpendicular to the thickness direction of the electrode plate 21, at least a part of the grooves 214 penetrate through the active material layer 212. This arrangement makes it convenient for the electrolyte solution to enter the clearance between the electrode plate 21 and the separator through the groove 214, thereby improving the electrolyte infiltration effect and reducing the risk of electrolyte flow discontinuity and occurrence of black flecks.

In some embodiments, the width of the groove 214 is 80 μm to 120 μm. The width of each groove 214 is defined as W, satisfying: 80 μm≤W≤120 μm. The width of the groove 214 satisfying the specified range can increase the amount of electrolyte solution between the electrode plate 21 and the separator, thereby improving the electrolyte infiltration effect between the electrode plate 21 and the separator, reducing the capacity loss of the electrode plate 21, and in turn, reducing the probability of electrolyte flow discontinuity and occurrence of black flecks.

As an example, W may be any one of 80 μm, 82 μm, 84 μm, 85 μm, 86 μm, 88 μm, 90 μm, 92 μm, 94 μm, 95 μm, 96 μm, 98 μm, 100 μm, 102 μm, 104 μm, 105 μm, 106 μm, 108 μm, 110 μm, 112 μm, 114 μm, 115 μm, 116 μm, 118 μm, or 120 μm.

In some embodiments, referring to FIG. 4 and FIG. 5, the distance between any two adjacent grooves 214 is 0.5 mm to 2.5 mm. This arrangement prevents the grooves 214 from being arranged ultra-densely or ultra-sparsely. When the grooves 214 are arranged ultra-densely, the decrease in the active material layer 212 is prone to be excessive. When the grooves 214 are arranged ultra-sparsely, it is difficult to ensure sufficient electrolyte solution between the electrode plate 21 and the separator. When the distance between any two adjacent grooves 214 satisfies the specified range of 0.5 mm to 2.5 mm, it is convenient for the electrode plate 21 to maintain a sufficient amount of active material layer 212, thereby reducing the capacity loss of the electrode plate 21, increasing the amount of electrolyte solution between the electrode plate 21 and the separator, and in turn, improving the electrolyte infiltration effect between the electrode plate 21 and the separator.

To verify the impact of the dimensions of the grooves 214 on the infiltration effect of the electrode plate 21 and the capacity of the electrode plate 21, the following tests are performed:

### Black Fleck Test

Performing a cycling test on a secondary battery 100: Placing the secondary battery 100 in a 25° C. environment, and leaving the battery to stand for 30 minutes, and then charging and discharging the battery in the following steps. Charging the battery at a constant current of 2.5C until the voltage reaches 4.2 V, and then charging the battery at a constant voltage until the current drops to 0.5C; charging the battery at a constant current of 0.5C until the voltage reaches 4.45 V, and then charging the battery at a constant voltage until the current drops to 0.02C; leaving the battery to stand for 5 minutes; discharging the battery at constant current of 1C until the voltage drops to 3 V; and leaving the battery to stand for 5 minutes, thereby completing one cycle. Repeating the above operations for 300 cycles, and then disassembling the secondary battery 100 and taking out the negative electrode plate. Observing whether any black flecks exist on the negative electrode plate, and detecting the area of the black flecks if any.

In the above test, 20 batteries are taken as test pieces from each embodiment or comparative embodiment. If no black flecks are detected on the electrode assembly 20 or if the area of the black flecks is less than 3 mm², it is determined that the battery passes the test. Pass rate=(number of batteries that pass the test/20)×100%.

### Lithium Plating Test

Performing a cycling test on a secondary battery 100: Placing the secondary battery 100 in a 25° C. environment, and leaving the battery to stand for 30 minutes, and then charging and discharging the battery in the following steps. Charging the battery at a constant current of 2.5C until the voltage reaches 4.2 V, and then charging the battery at a constant voltage until the current drops to 0.5C; charging the battery at a constant current of 0.5C until the voltage reaches 4.45 V, and then charging the battery at a constant voltage until the current drops to 0.02C; leaving the battery to stand for 5 minutes; discharging the battery at constant current of 1C until the voltage drops to 3 V; and leaving the battery to stand for 5 minutes, thereby completing one cycle. Repeating the above operations for 300 cycles, and then disassembling the secondary battery 100 and taking out the negative electrode plate. Observing whether lithium plating occurs on the negative electrode plate, and detecting the lithium plating area if any.

In the above test, 100 batteries are taken as test pieces from each embodiment or comparative embodiment. If no lithium plating occurs on the electrode assembly 20 or if the lithium plating area is less than 3 mm², it is determined that the battery passes the test. Pass rate=(number of batteries that pass the test/100)×100%.

The following describes the specific implementations of the secondary batteries 100 in the embodiments and comparative embodiments.

### Embodiments

A secondary battery 100 is assembled in the following process:

(1) Preparing a negative electrode plate: Mixing artificial graphite as a negative active material, conductive carbon black (Super P), and the styrene butadiene rubber (SBR) at a weight ratio of 96:1.5:2.5, adding deionized water as a solvent, blending the mixture into a slurry in which the mass percent of the solid is 70 wt %, and stirring well. Coating one surface of a 10 μm-thick negative current collector copper foil with the slurry evenly, reserving a blank foil region at the edge of the copper foil, and drying the slurry at a temperature of 110° C. to obtain a negative electrode plate coated with a 150 μm-thick negative active material layer on one side. Repeating the foregoing steps on the other surface of the negative electrode plate to obtain a negative electrode plate coated with the negative active material layer on both sides. Subsequently, cutting away the excess blank foil region (the part not coated with the negative active material) by a laser cutting process, so as to obtain a negative tab.

(2) Preparing a groove 214: Dividing the coating region coated with a negative active material on both sides on the negative electrode plate into 3 first regions 210 from the center of the electrode plate 21 to the periphery of the electrode plate 21. Each first region 210 is a rectangular region. The 1st first region 210 surrounds the 2^{nd} first region 210, and the 2^{nd} first region 210 surrounds the 3^{rd} first region 210. The center of the 3^{rd} first region 210 coincides with the center of the electrode plate 21. In this way, the plurality of first regions 210 are arranged in approximately a concentric square shape. Cutting out a plurality of grooves 214 in each first region 210 by a laser cutting process, where the plurality of grooves 214 extend along the length direction Y of the electrode plate 21 and penetrate through the active material layer along the length direction. The plurality of grooves 214 are also arranged along the width direction X of the electrode plate 21. The depths of the plurality of grooves 214 are arranged in a gradient from the center of the electrode plate 21 to the periphery of the electrode plate 21. The groove 214 in the first region 210 closer to the center is deeper. It is defined that the depth of the groove 214 in the 1st first region 210 is H₁, the depth of the groove 214 in the 2^{nd} first region 210 is H₂, and the depth of the groove 214 in the 3^{rd} first region 210 is defined as H₃. It is defined that the width of the groove 214 in the 1st first region 210 is W₁, the width of the groove 214 in the 2^{nd} first region 210 is W₂, and the width of the groove 214 in the 3^{rd} first region 210 is W₃. It is defined that the percentage of the area of the 3^{rd} first region 210 in relation to the area of the electrode plate is S₃.

(3) Preparing a positive electrode plate: Mixing lithium cobalt oxide (LiCoO₂) as a positive active material, conductive carbon black (super P), and polyvinylidene difluoride (PVDF) at a weight ratio of 97.5:1.0:1.5, and adding N-methyl pyrrolidone (NMP) as a solvent to form a slurry in which a solid content is 75 wt %, and stirring well. Coating one surface of a 12 μm-thick positive current collector aluminum foil evenly with the slurry, reserving a blank foil region at the edge of the aluminum foil, and then drying the slurry at a temperature of 90° C. to obtain a positive electrode plate coated with a 100 μm-thick positive active material layer. Repeating the above coating steps on the other surface of the aluminum foil to prepare another first electrode plate 21 coated with the active material layer on both sides. Subsequently, cutting away the excess blank foil region by a laser die-cutting process, so as to obtain a positive tab.

(4) Preparing an electrolyte solution: Mixing ethylene carbonate (EC), ethyl methyl carbonate (EMC), and diethyl carbonate (DEC) at a weight ratio of EC: EMC: DEC=30:50:20 in an dry argon atmosphere to form a base organic solvent, then adding lithium salt hexafluorophosphate (LiPF₆) into the base organic solvent to dissolve, and mixing the solution evenly to obtain an electrolyte solution in which a lithium salt concentration is 1.15 mol/L.

(5) Preparing a separator: Using a three-layer separator, where the separator includes a first adhesive layer, a first substrate layer, and a first adhesive layer stacked in layers. The first substrate layer is made of polyethylene (PE). The first adhesive layer contains a first binder. The first adhesive layer further contains inorganic ceramic particles Al₂O₃.

(6) Preparing an electrode assembly 20: Stacking the positive electrode plate, the separator, and the negative electrode plate, and using a flat plate to hot-press the stacked structure for 10 seconds at a temperature of 80° C. and a pressure of 1.5 MPa to form an electrode assembly 20 for future use.

(7) Assembling the electrode assembly 20: Placing a punch-molded aluminum laminated film into an assembly jig, with a cavity side facing upward. Placing the electrode assembly 20 into the cavity, and pressing the film tightly by exerting an external force. Subsequently, overlaying the electrode assembly 20 with another punch-molded aluminum laminated film, with the cavity side facing downward. Heat-sealing the periphery of the two aluminum laminated films by hot pressing to obtain an assembled electrode assembly 20.

(8) Electrolyte injection and packaging: Injecting an electrolyte solution into the assembled electrode assembly 20, and performing steps such as vacuum sealing, static standing, hot-pressing, chemical formation, and shaping to obtain a secondary battery 100.

### Comparative Embodiment

The comparative embodiment differs from the embodiments in that step (2) described in the embodiment is omitted in the comparative embodiment, and neither the negative electrode plate nor the positive electrode plate is provided with the groove 214.

The main parameters and test results of each embodiment and comparative embodiment are shown in Table 1:

TABLE 1

| | | | | | | | | | Black fleck | Lithium | |
|---|---|---|---|---|---|---|---|---|---|---|---|
| | | | | | Groove | | | | test pass | plating test | |
| | | | | W₁/W₂/W₃ | spacing | | | H₃ − H₂ | rate | pass | Capacity |
| Serial number | H₁ (μm) | H₂ (μm) | H₃ (μm) | (μm) | (mm) | S₃ (%) | H₂ − H₁ (μm) | (μm) | (%) | rate (%) | loss (%) |
| Comparative | 0 | 0 | 0 | \ | \ | \ | \ | \ | 17.00 | 19.00 | 0.00 |
| Embodiment 1 | | | | | | | | | | | |
| Comparative | 22 | 22 | 27 | 100 | 1.5 | 30 | 0 | 5 | 38.03 | 50.00 | 0.07 |
| Embodiment 2 | | | | | | | | | | | |
| Comparative | 27 | 22 | 27 | 100 | 1.5 | 30 | −5 | 5 | 35.53 | 57.00 | 0.08 |
| Embodiment 3 | | | | | | | | | | | |
| Comparative | 22 | 27 | 27 | 100 | 1.5 | 30 | 5 | 0 | 35.53 | 20.00 | 0.08 |
| Embodiment 4 | | | | | | | | | | | |
| Comparative | 27 | 32 | 27 | 100 | 1.5 | 30 | 5 | −5 | 31.40 | 25.00 | 0.09 |
| Embodiment 5 | | | | | | | | | | | |
| Comparative | 32 | 32 | 27 | 100 | 1.5 | 30 | 0 | −5 | 29.67 | 27.00 | 0.09 |
| Embodiment 6 | | | | | | | | | | | |
| Comparative | 37 | 32 | 27 | 100 | 1.5 | 30 | −5 | −5 | 28.13 | 27.00 | 0.10 |
| Embodiment 7 | | | | | | | | | | | |
| Comparative | 32 | 27 | 27 | 100 | 1.5 | 30 | −5 | 0 | 31.40 | 28.00 | 0.09 |
| Embodiment 8 | | | | | | | | | | | |
| Comparative | 27 | 27 | 27 | 100 | 1.5 | 30 | 0 | 0 | 33.33 | 44.00 | 0.08 |
| Embodiment 9 | | | | | | | | | | | |
| Embodiment 1 | 15 | 21 | 27 | 100 | 1.5 | 30 | 6 | 6 | 97.00 | 100.00 | 0.06 |
| Embodiment 2 | 6 | 12 | 18 | 100 | 1.5 | 30 | 6 | 6 | 71.00 | 81.00 | 0.04 |
| Embodiment 3 | 9 | 15 | 21 | 100 | 1.5 | 30 | 6 | 6 | 95.00 | 98.00 | 0.05 |
| Embodiment 4 | 12 | 18 | 24 | 100 | 1.5 | 30 | 6 | 6 | 99.00 | 96.00 | 0.05 |
| Embodiment 5 | 20 | 26 | 32 | 100 | 1.5 | 30 | 6 | 6 | 97.00 | 99.00 | 0.08 |
| Embodiment 6 | 24 | 30 | 36 | 100 | 1.5 | 30 | 6 | 6 | 100.00 | 97.00 | 0.09 |
| Embodiment 7 | 28 | 34 | 40 | 100 | 1.5 | 30 | 6 | 6 | 96.00 | 92.00 | 0.10 |
| Embodiment 8 | 31 | 37 | 43 | 100 | 1.5 | 30 | 6 | 6 | 81.00 | 65.00 | 0.11 |
| Embodiment 9 | 22 | 27 | 32 | 100 | 1.5 | 30 | 5 | 5 | 97.00 | 98.00 | 0.08 |
| Embodiment 10 | 16 | 24 | 32 | 100 | 1.5 | 30 | 8 | 8 | 96.00 | 99.00 | 0.07 |
| Embodiment 11 | 8 | 20 | 32 | 100 | 1.5 | 30 | 12 | 12 | 95.00 | 96.00 | 0.06 |
| Embodiment 12 | 2 | 17 | 32 | 100 | 1.5 | 30 | 15 | 15 | 95.00 | 99.00 | 0.05 |
| Embodiment 13 | 15 | 21 | 27 | 100 | 1.5 | 15 | 6 | 6 | 85.00 | 84.00 | 0.04 |
| Embodiment 14 | 15 | 21 | 27 | 100 | 1.5 | 20 | 6 | 6 | 100.00 | 98.00 | 0.06 |
| Embodiment 15 | 15 | 21 | 27 | 100 | 1.5 | 40 | 6 | 6 | 98.00 | 98.00 | 0.07 |
| Embodiment 16 | 15 | 21 | 27 | 100 | 1.5 | 50 | 6 | 6 | 99.00 | 98.00 | 0.06 |
| Embodiment 17 | 15 | 21 | 27 | 100 | 1.5 | 60 | 6 | 6 | 81.00 | 67.00 | 0.07 |
| Embodiment 18 | 15 | 21 | 27 | 80 | 1.5 | 30 | 6 | 6 | 97.00 | 98.00 | 0.06 |
| Embodiment 19 | 15 | 21 | 27 | 90 | 1.5 | 30 | 6 | 6 | 95.00 | 95.00 | 0.06 |
| Embodiment 20 | 15 | 21 | 27 | 120 | 1.5 | 30 | 6 | 6 | 98.00 | 97.00 | 0.06 |
| Embodiment 21 | 15 | 21 | 27 | 100 | 0.5 | 30 | 6 | 6 | 99.00 | 96.00 | 0.07 |
| Embodiment 22 | 15 | 21 | 27 | 100 | 1 | 30 | 6 | 6 | 96.00 | 97.00 | 0.07 |
| Embodiment 23 | 15 | 21 | 27 | 100 | 2 | 30 | 6 | 6 | 100.00 | 97.00 | 0.06 |
| Embodiment 24 | 15 | 21 | 27 | 100 | 2.5 | 30 | 6 | 6 | 99.00 | 99.00 | 0.06 |

As can be seen from Table 1 above, in contrast to Comparative Embodiments 1 to 9, Embodiment 1 satisfies H₁<H₂<H₃, thereby improving the electrolyte infiltration effect of the electrode 21 and suppressing the occurrence of black flecks. In addition, the grooves 214 in the 1st first region 210 and the 2^{nd} first region 210 that can be infiltrated without difficulty are relatively narrow in depth, thereby making it convenient to provide a larger amount of active material layer 212, and in turn, suppressing lithium plating and reducing the capacity loss of the electrode plate 21.

As can be seen from Table 1 above, in contrast to Embodiments 2 and 8, Embodiments 2 to 7 satisfy: 21≤H₃<40, thereby increasing the amount of electrolyte solution between the first region 210 located at the center of the electrode plate 21 and the separator, improving the electrolyte infiltration effect at the center of the electrode plate 21, and in turn, further reducing the probability of electrolyte flow discontinuity and occurrence of black flecks at the center of the electrode plate 21.

As can be seen from Table 1 above, Embodiments 9 to 12 satisfy: 5 μm≤ H₃−H_{2≤15} μm, and 5 μm≤H₂−H_{1≤15} μm, thereby. In this way, the difference in depth of grooves 214 between the two adjacent first regions 210 is prevented from being excessively large, thereby making it convenient for the electrode plate 21 to form more gradient levels, reducing the capacity loss of the electrode plate 21, and suppressing the occurrence of lithium plating. Satisfying the specified range also prevents the difference in depth of grooves 214 between the two adjacent first regions 210 from being excessively small, thereby making it convenient to increase the amount of electrolyte solution between the electrode plate 21 and the separator, and in turn, making it convenient to improve the electrolyte infiltration effect of the electrode plate 21, suppressing the occurrence of black flecks, and achieving a more reasonable trade-off between the improvement of the electrolyte infiltration effect of the electrode plate 21 and the reduction of the capacity loss.

As can be seen from Table 1 above, in contrast to Embodiments 13 and 17, Embodiment 1 and Embodiments 14 to 16 satisfy 20%≤S₃≤50%. The S₃ satisfying this range can reduce the probability of electrolyte flow discontinuity and occurrence of black flecks at the center of the electrode plate 21, thereby reducing the capacity loss of the electrode plate 21 and suppressing the occurrence of lithium plating.

As can be seen from Table 1 above, Embodiment 1 and Embodiments 18 to 20 satisfy: 80 μm≤W₁≤120 μm, 80 μm≤W₂≤120 μm, and 80 μm≤W₃≤120 μm. The width W of the groove 214 satisfying this range can increase the amount of electrolyte solution between the electrode plate 21 and the separator, thereby improving the electrolyte infiltration effect between the electrode plate 21 and the separator, suppressing the occurrence of black flecks, reducing the capacity loss of the electrode plate 21, and suppressing lithium plating.

As can be seen from Table 1 above, Embodiment 1 and Embodiments 21 to 24 satisfy that the distance between any two adjacent grooves 214 is 0.5 mm to 2.5 mm, thereby preventing the grooves 214 from being excessively dense or excessively sparse. When the distance between the grooves 214 satisfies the specified range of 0.5 mm to 2.5 mm, it is convenient for the electrode plate 21 to maintain a sufficient amount of active material layer 212, thereby reducing the capacity loss of the electrode plate 21, suppressing the occurrence of lithium plating, increasing the amount of electrolyte solution between the electrode plate 21 and the separator, and in turn, improving the electrolyte infiltration effect between the electrode plate 21 and the separator, and suppressing the occurrence of black flecks.

In some embodiments, referring to FIG. 4, along a direction perpendicular to the thickness direction of the electrode plate 21, at least a part of the grooves 214 penetrate through the active material layer 212. Along the extension direction of the groove 214, the electrode terminal 213 is located on one side of the current collector 211. The active material layer 212 includes a first part 2121 and a second part 2122. The first part 2121 is stacked together with the current collector 211, and the second part 2122 is stacked together with a part of the electrode terminal 213. Along the extension direction of the groove 214, a minimum distance between the groove 214 and an edge, oriented away from the first part 2121, of the second part 2122 is 0.1 mm to 1 mm. In this way, the processing region is distanced from a part, uncoated with an active material layer 212, of the electrode terminal 213, thereby reducing the risk of damage to the electrode terminal 213 during the processing of the groove 214.

In some embodiments, the groove 214 may be processed by a laser beam. To be specific, a laser beam is emitted toward the electrode plate 21 along the thickness direction Z of the electrode plate 21. With the movement of the laser beam, a groove 214 extending along the laser path is formed on the electrode plate 21.

In some other embodiments, the groove 214 may be processed by a cutting tool. The groove 214 may be processed by other means, the details of which are not enumerated here.

In some embodiments, referring to FIG. 4, the S^{th} first region 210 surrounds the (S+1)^{th} first region 210. In this way, all the 1st to (N-1)^{th} first regions 210 are rectangular regions or annular regions, thereby making a plurality of first regions 210 more compliant with the law of electrolyte infiltration, and more favorably improving the electrolyte infiltration effect of the electrode plate 21 and reducing the capacity loss of the electrode plate 21 simultaneously.

In the above embodiment in which all the first regions 210 are rectangular regions or annular regions, referring to FIG. 4, the extension directions of the grooves 214 in each first region 210 are parallel to each other, and the grooves 214 in any two adjacent first regions 210 are arranged in one-to-one correspondence. The grooves 214 in each first region 210 may communicate to the corresponding grooves 214 in an adjacent first region 210, thereby improving the efficiency of electrolyte infiltration to the region close to the center on the electrode plate 21, and in turn, reducing the risk of electrolyte flow discontinuity and occurrence of black flecks.

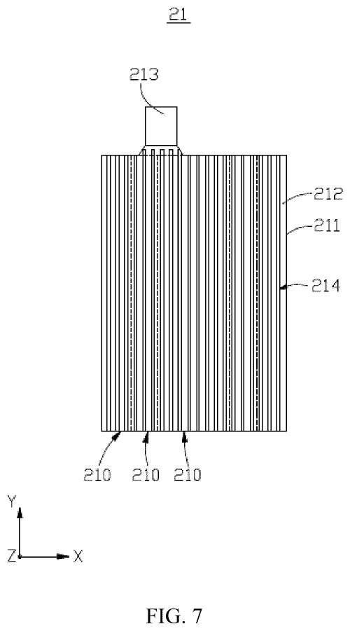

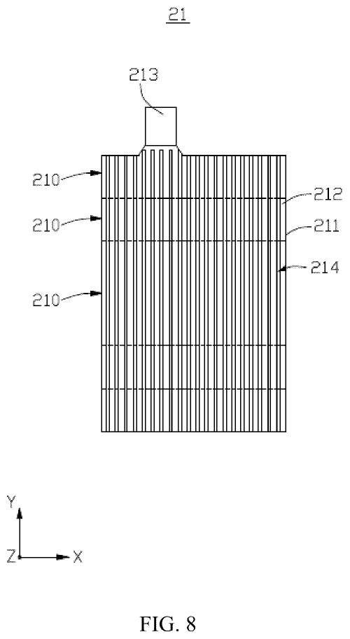

In some embodiments, referring to FIG. 7 and FIG. 8, along a direction perpendicular to the thickness direction of the electrode plate 21, a part of the S^{th} first region 210 is located on one side of the (S+1)^{th} first region 210, and another part of the S^{th} first region 210 is located on an opposite side of the (S+1)^{th} first region 210. In this way, the arrangement of the plurality of grooves 214 is simpler, thereby improving the processing efficiency of the grooves 214.

In some embodiments, referring to FIG. 7, a plurality of first regions 210 are arranged along the width direction X of the electrode plate 21. Such an arrangement improves the processing efficiency of the groove 214.

In some embodiments, referring to FIG. 8, a plurality of first regions 210 are arranged along the length direction Y of the electrode plate 21. Such an arrangement improves the processing efficiency of the groove 214.

In some embodiments, referring to FIG. 7 and FIG. 8, the extension directions of all the grooves 214 are parallel to each other, thereby facilitating batch processing and improving the processing efficiency of the grooves 214.

In some embodiments, referring to FIG. 7 and FIG. 8, the extension direction of the groove 214 is perpendicular to the arrangement direction of the first regions 210. This arrangement eliminates the need for each groove to extend across a plurality of first regions 210, and improves the processing efficiency of the groove 214.

In some embodiments, the electrode plate 21 is a negative electrode plate. The consumption speed of the electrolyte solution between the negative electrode plate and the separator is faster than the consumption speed of the electrolyte solution between the positive electrode plate and the separator. When the technical solution about the groove 214 and the first region 210 in any one of the above embodiments is applied to the negative electrode plate, the electrolyte infiltration is improved to a greater degree, thereby being more conducive to reducing the risk of electrolyte flow discontinuity and occurrence of black flecks.

In some embodiments, N second regions (not shown in the drawing) are disposed on the positive electrode plate. The (S+1)^{th} second region is closer to the center of the positive electrode plate than the S^{th} second region. Along the thickness direction of the negative electrode plate, a projection of the N^{th} first region 210 overlaps a projection of the N^{th} second region. A ratio of the capacity of the N^{th} first region 210 to the capacity of the N^{th} second region is C, satisfying: 1.02≤C≤1.5.

Because the first region 210 on the negative electrode plate is provided with a groove 214, the capacity of the first region 210 of the negative electrode plate is less than the capacity of the corresponding second region on the positive electrode plate. By making C satisfy the condition of 1.02≤C≤1.5, it is more convenient for the grooves 214 in the first region 210 to improve the electrolyte infiltration effect of the electrode plate 21 and reduce the capacity loss of the electrode plate 21 simultaneously.

### Method for Determining the Capacity of the Negative Electrode Plate

Cutting out different regions of a negative electrode plate to obtain discs of 12 mm in diameter, using one of the discs as a negative electrode to assemble a coin cell, and then performing a charge-discharge test on the coin cell. The specific test process is: charging the coin cell at a constant current of 0.2C until the voltage reaches 4.45 V, and then charging the coin cell at a constant voltage until the current drops to 0.02C; leaving the coin cell to stand for 5 minutes, and then discharging the coin cell at a constant current of 0.2C until the voltage drops to 3 V; and leaving the coin cell to stand for 5 minutes, thereby completing one cycle. Recording the discharge capacity.

### Capacity Loss Test

The first-cycle discharge capacity of the secondary battery 100 in Embodiment 1 after completion of assembling is denoted as R1, and the first-cycle discharge capacity of the secondary battery 100 in other comparative embodiments and embodiments after completion of assembling is denoted as R2.

$$Capacity loss = ( R 1 / R 2 - 1 ) \times 100 \%$$

### Cell Balance Test Method

Taking fully discharged lithium-ion secondary batteries 100, disassembling each battery separately and taking out a positive electrode plate and a negative electrode plate. Cleaning and then drying the positive electrode plate and the negative electrode plate. Using a die with a diameter of 14 mm to punch out 5 complete specimens from a flat single-side-coated region of the positive electrode plate and the negative electrode plate separately, using a lithium sheet as a counter electrode, and assembling each of the specimens with the counter electrode to form a coin cell for testing. Testing the specimens of the positive electrode plate with reference to the capacity test method of the negative electrode plate, measuring the capacities of the specimens of the positive electrode plate, denoted C1, C2, C3, C4, and C5, respectively, and calculating the average capacity of the cut-out specimens of the positive electrode, denoted as Cₚₒₛᵢₜᵢᵥₑ. Similarly, measuring the capacities of the specimens of the negative electrode plate, denoted as A1, A2, A3, A4, A5, respectively, and then calculating the average capacity of the cut-out specimens of the negative electrode, denoted as A_{negative}, satisfying: CB=A_{negative}/Cₚₒₛᵢₜᵢᵥₑ.

In this application, the term “CB” refers to cell balance. The CB value may represent a capacity ratio of the negative electrode plate to the positive electrode plate in a secondary battery 100.

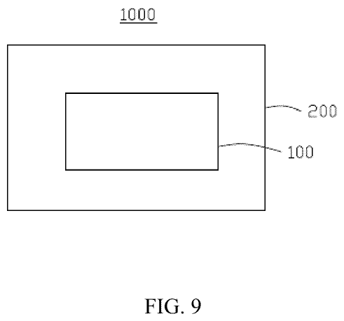

Referring to FIG. 9, an embodiment of this application further provides an electronic device 1000. The electronic device 1000 includes the secondary battery 100 disclosed in any one of the above embodiments. The electronic device 1000 employs the technical solutions of the secondary battery 100 disclosed in any one of the above embodiments, and therefore, achieves at least the beneficial effects brought by the technical solutions of the secondary battery 100 disclosed in any one of the above embodiments, the details of which are omitted here.

In some embodiments, referring to FIG. 9, the electronic device 1000 further includes a device body 200. The secondary battery 100 is mounted in the device body 200.

In some embodiments, the electronic device 1000 may be a mobile phone, a tablet computer, an e-reader, AR glasses, VR glasses, or the like, the detailed items of which are not enumerated here one by one.

In addition, a person of ordinary skill in the art understands that the foregoing embodiments are merely intended to illustrate this application, but not intended to limit this application. Any and all appropriate modifications and changes made to the embodiments without departing from the essence of this application still fall within the protection scope of this application.

What is claimed is:

1. An electrode plate, wherein the electrode plate comprises a current collector and an active material layer that are stacked, the electrode plate is provided with N first regions, and the active material layer in each first region is provided with a groove; and
an (S+1)^{th} first region is closer to a center of the electrode plate than an S^{th} first region, a depth of the groove located in the S^{th} first region is H_{S}, and a depth of the groove located in the (S+1)^{th} first region is H_{S+1}, wherein H_{S}<H_{S+1},
N is a positive integer greater than or equal to 2, and S is a positive integer greater than or equal to 1 and less than N.

2. The electrode plate according to claim 1, wherein the center of the electrode plate is located in an N^{th} first region.

3. The electrode plate according to claim 2, wherein a center of the N^{th} first region coincides with the center of the electrode plate.

4. The electrode plate according to claim 1, wherein the N^{th} first region accounts for 20% to 50% of an area of the electrode plate.

5. The electrode plate according to claim 1, wherein N is 3, a sum of areas of the 3 first regions is less than or equal to an area of the electrode plate, and each first region accounts for 20% to 40% of the area of the electrode plate.

6. The electrode plate according to claim 1, wherein a depth of the groove in the 1^{st} first region is H₁, satisfying: 0<H_{S+1}−H_{S}<H₁.

7. The electrode plate according to claim 6, wherein the electrode plate satisfies:
$$5 μm \leq {H}_{S + 1} - {H}_{S} \leq 15 μm .$$

8. The electrode plate according to claim 1, wherein a depth of the groove in an N^{th} first region is 21 μm to 40 μm.

9. The electrode plate according to claim 8, wherein, along a direction perpendicular to a thickness direction of the electrode plate, at least a part of the groove penetrate through the active material layer.

10. The electrode plate according to claim 9, wherein a width of the groove is 80 μm to 120 μm.

11. The electrode plate according to claim 10, wherein a distance between any two adjacent grooves is 0.5 mm to 2.5 mm.

12. The electrode plate according to claim 9, wherein the electrode plate further comprises an electrode terminal, the electrode terminal is connected to the current collector, and, along an extension direction of the groove, the electrode terminal is located on one side of the current collector;
the active material layer comprises a first part and a second part, the first part is stacked together with the current collector, and the second part is stacked together with a part of the electrode terminal; and
along the extension direction of the groove, a minimum distance between the groove and an edge of the second part is 0.1 mm to 1 mm, the edge of the second part being oriented away from the first part.

13. The electrode plate according to claim 1, wherein the S^{th} first region surrounds the (S+1)^{th} first region.

14. The electrode plate according to claim 2, wherein the S^{th} first region surrounds the (S+1)^{th} first region.

15. The electrode plate according to claim 1, wherein, along a direction perpendicular to a thickness direction of the electrode plate, a part of the S^{th} first region is located on one side of the (S+1)^{th} first region, and another part of the S^{th} first region is located on an opposite side of the (S+1)^{th} first region.

16. The electrode plate according to claim 1, wherein the electrode plate is a negative electrode plate.

17. A secondary battery, wherein the secondary battery comprises an electrode assembly, the electrode assembly comprises a separator and the electrode plate according to claim 16, the electrode assembly further comprises a positive electrode plate, and the separator is disposed between the negative electrode plate and the positive electrode plate.

18. The secondary battery according to claim 17, wherein N second regions are disposed on the positive electrode plate, and the (S+1)^{th} second region is closer to a center of the positive electrode plate than the S^{th} second region; and
along a thickness direction of the negative electrode plate, a projection of an N^{th} first region overlaps a projection of an N^{th} second region, and a ratio of a capacity of the N^{th} first region to a capacity of the N^{th} second region is C, satisfying: 1.02≤C≤1.5.

19. An electronic device, wherein the electronic device comprises the secondary battery according to claim 16.

20. The electronic device according to claim 19, wherein N second regions are disposed on the positive electrode plate, and the (S+1)^{th} second region is closer to a center of the positive electrode plate than the S^{th} second region; and
along a thickness direction of the negative electrode plate, a projection of an N^{th} first region overlaps a projection of an N^{th} second region, and a ratio of a capacity of the N^{th} first region to a capacity of the N^{th} second region is C, satisfying: 1.02≤C≤1.5
